(19) United States
(12) Patent Application Publication
(10) Pub. No.: US 2019/0055843 A1
(43) Pub. Date: Feb. 21, 2019

(54) AIR-FOIL BOUNDARY LAYER TURBINE

(71) Applicant: TrybriDrive LLC, Sedona, AZ (US)

(72) Inventors: Bruce Richard Berkson, Sedona, AZ (US); Ronald J. Chase, Bend, OR (US)

(73) Assignee: TrybriDrive LLC, Sedona, AZ (US)

(21) Appl. No.: 15/679,371

(22) Filed: Aug. 17, 2017

(51) Int. Cl. F01D 1/36; F01D 5/04

(52) U.S. Cl. CPC F01D 1/36; F05D 2240/24; F05D 2220/31; F01D 5/048

(57) ABSTRACT

A boundary layer turbine includes a housing having a fluid inlet and a fluid outlet and a rotatable shaft at least partially disposed within the housing. Two or more rotor discs are coupled to the shaft in spaced relation to one another. Spacers are attached to at least a plurality of the rotor discs. The spacers are configured so as to provide a lifting force as fluid is passed over the spacers. An inner surface of the housing as well as the outer 25% of the disc surface may have spaced apart depressions formed thereon to assist in fluid flow passing more freely between the housing and the rotor discs, as well as along the outer leading edge of the disk.

### BACKGROUND OF THE INVENTION

The present invention generally relates to turbines. More particularly, the present invention relates to an improved boundary layer turbine having spacers configured to provide a lifting force as fluid passes over the spacers to combine desirable high-efficiency characteristics of a bladed reaction or impulse steam turbine with the relatively low entry temperature, simplicity and durability of a boundary layer turbine.

A boundary layer turbine uses the boundary layer effect and not a fluid impinging upon the blades as in a conventional turbine. Such turbines are sometimes referred to as a Tesla turbine, which is a bladeless centripetal flow turbine, invented by Nikola Tesla in the early 1900s. A boundary layer turbine, or Tesla turbine, consists of a set of smooth discs with nozzles applying a moving fluid to the edge of the disc. The fluid drags on the disc by means of viscosity and the adhesion of the surface layer of the fluid. As the fluid slows and adds energy to the discs, it spirals into the center exhaust. It is well known in the art that boundary layer turbines, also referred to as Tesla turbines, are low-cost, highly durable “bladeless” turbines that can utilize many forms of working fluids under a wide range of working temperatures and pressures.

However, boundary layer turbines have historically been found to have effective operating efficiencies below 50%. Moreover, the high internal temperature, pressure and rotational stresses experienced under long-term use can cause the rotor discs to fracture and otherwise fail.

Conventional bladed steam turbines require Rankine cycle entry point temperatures above 1,049° F., or otherwise they must lower the fluid boiling point by use of Organic Rankine Cycle fluids, which adulterates the pure working fluid, require special materials, and add to design complexity required for successful operation. However, such conventional bladed reaction or impulse steam turbines are relatively highly efficient.

Accordingly, there is a continuing need for improvements in the boundary layer turbine to increase the efficiency of the turbine and resist failure of the rotor discs. The present invention fulfills these needs, and provides other related advantages.

### SUMMARY OF THE INVENTION

The present invention resides in an improved boundary layer turbine, and related method, which is a high-efficiency working fluid turbine having hybridized traits of various turbine types. More particularly, an airfoil boundary layer turbine of the present invention combines the desirable high-efficiency characteristics of a bladed reaction or impulse steam turbine with the relatively low entry temperature, simplicity and durability of a boundary layer turbine. The present invention optimizes internal airflow, turbulence, adhesion and surface traction efficiency while strengthening the structure and stabilizing destructive blade oscillations which are observed in conventional boundary layer turbines when operating at high revolutions.

The boundary layer turbine of the present invention generally comprises a housing having a fluid inlet and a fluid outlet. A rotatable shaft is at least partially disposed within the housing. Two or more rotor discs are coupled to the shaft in spaced relation to one another. Spacers are attached to the face of at least a plurality of the rotor discs. The spacers have an elongated configuration, wherein a leading portion of the spacer has a greater surface area than a trailing portion of the spacer. The elongated spacers may comprise an airfoil. A lifting force is created as fluid passes over the elongated or airfoil spacers.

The elongated spacers may be spaced from an outer peripheral edge of the rotor disc and arranged end-to-end, such as in a generally circular pattern. A second set of elongated spacers may be arranged end-to-end in a generally circular pattern concentric to the first pattern. The turbine may also include a plurality of spacers having a generally circular configuration. The circular spacers may be disposed intermediate the elongated spacers and the rotor shaft.

The housing may comprise a case ring adjacent to peripheral edges of the rotor discs. An inner surface of the case ring has spaced apart depressions formed thereon. The spaced apart depressions, which may be formed as a pattern, creates a thin layer of turbulence as fluid passes over the inner surface of the case ring.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the invention. In such drawings:

FIG. 1 is a perspective view of a boundary layer turbine embodying the present invention;

FIG. 2 is an exploded perspective view of various components of the turbine;

FIG. 3 is an end view of a rotor disc and an inlet of the turbine, the rotor disc including elongated spacers having an airfoil configuration in accordance with the present invention;

FIG. 4 is an end view of a rotor disc having elongated spacers arranged end-to-end in a concentric pattern, in accordance with the present invention;

FIG. 5 is a side view of a sectioned case ring or portion of the turbine housing, having spaced apart depressions formed therein, in accordance with the present invention;

FIG. 6 is a side perspective view of the housing ring of FIG. 5; and

FIG. 7 is an end view of a rotor disc and an inlet of the turbine, showing a dimpled outer area of the disk.

### DETAILED DESCRIPTION OF THE PREFERRED EMBODIMENTS

As shown in the accompanying drawings, for purposes of illustration, the present invention resides in an improved boundary layer turbine, generally referred to by the reference number 10. The turbine 10 of the present invention has hybridized traits of different turbine types, including an airfoil boundary layer turbine that combines the desirable high efficiency characteristics of a bladed reaction or impulse steam turbine with the relatively low entry temperature, simplicity and durability of a boundary layer turbine. The turbine 10 of the present invention optimizes internal air flow resistance, turbulence, adhesion, and surface traction efficiency while strengthening the blade structure and stabilizing destructive blade oscillations observed in conventional boundary layer turbines when operating at high revolutions.

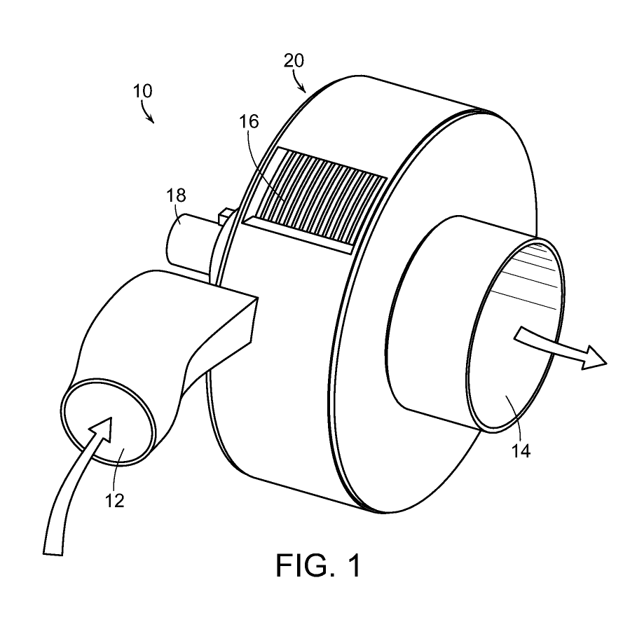

With reference now to FIG. 1, an exemplary turbine 10 embodying the present invention is shown. The turbine 10 includes a fluid inlet 12 and a fluid outlet 14. The fluid may comprise any type of fluid, including compressed air, steam or liquid. As is known in the art, as the fluid enters the inlet it comes into contact with spaced apart rotor discs 16 which are operably coupled to a rotatable shaft 18. At least a portion of the shaft 18 and the discs 16 are disposed within a housing 20. As the fluid is passed over the discs 16, the fluid drags on the discs, causing the discs 16 to rotate, which rotates the shaft 18. The fluid slows as it adds energy to the discs 16 and spirals into a center exhaust port, which leads to the exhaust outlet 14.

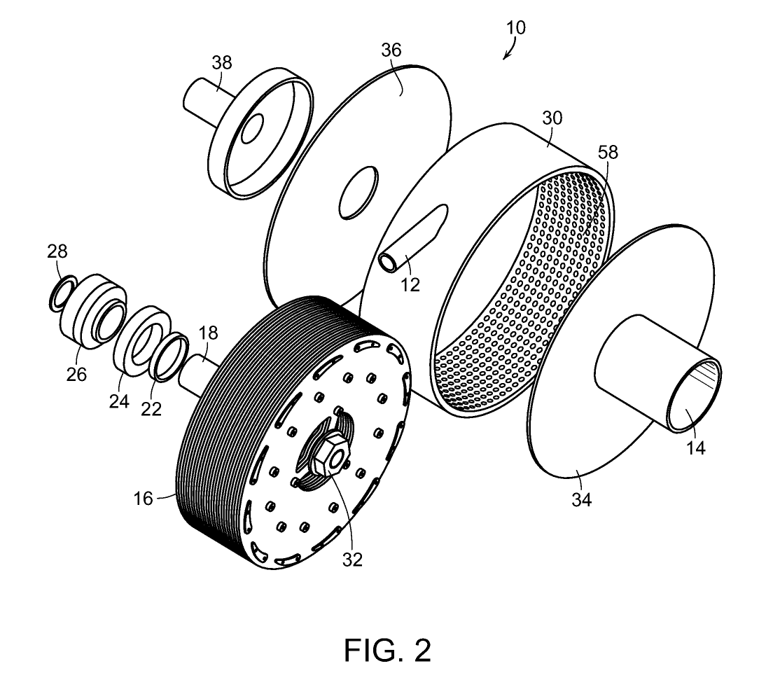

With reference now to FIG. 2, an exploded view of the turbine 10 shows typical component parts thereof. On one side of the discs, a bearing housing 38 supports shaft 18 and also supports seals 22 that prevent the fluid from escaping the housing. Ball bearings 24 enable the shaft 18 to rotate. Compression or stop collars 26 are held in place with a snap ring 28 and hold the ball bearing and seal components in place on the shaft 18. A shaft lock nut 32 may be used to hold the discs 16 to the shaft 18. Another embodiment may also include bearings and seals, and exhausts on both sides of the discs.

The housing 20 may comprise a tubular case ring 30 which is slightly spaced apart from and surrounds the rotatable disc 16. Typically, as illustrated in FIG. 2, an exhaust side housing plate 34 is disposed on one side of the case ring 30 and a bearing side housing plate 36 is disposed on the opposite side of the case ring 30. A bearing housing 38 houses the bearings, collars, seals, etc. 22-28. The plates and housings 34-38 have apertures and areas, as needed, to accommodate structures extending therein, such as the shaft 18. Moreover, the exhaust side housing plate 34 includes exhaust 14. It will be appreciated, however, that other configurations are possible and still achieve the purposes of the present invention.

In a traditional Tesla or boundary layer turbine design, circular spacers, which may comprise washers, are used between the discs of the rotor assembly. These washers provide exact spacing for the passage of the working fluid between the discs. In addition, they present a curved surface perpendicular to the high velocity working fluid driving the rotor assembly of the turbine. Each time the leading edge curved surface of a circular washer or spacer rotates into the working fluid stream coming from the input nozzle at the perimeter at the turbine, a torque impulse is created. These impulses collectively improve low end startup torque.

When the velocity of the working fluid is greater than the speed of the washers or circular spacers in the rotating rotor, a low pressure zone occurs on the back side of the circular spacers in the direction of rotor rotation. This pressure differential propels the spacer forward. The energy absorbed by the circular washer or spacer adds to the total energy absorbed by the disc assembly. This interaction between working fluid and spacers is most efficient at the outer perimeter of the discs, such that the distance of the spacers to the shaft of the rotor assembly acts as a lever to effectively increase torque.

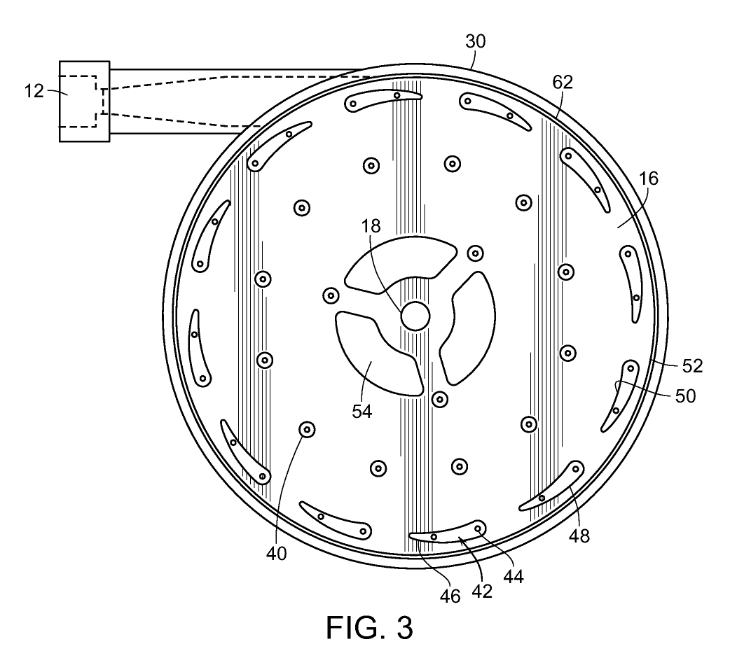

With reference to FIG. 3, such conventional circular spacers or washers 40 are shown incorporated into an embodiment of the present invention. However, in accordance with the present invention, at least a plurality of the circular spacers are replaced with spacers 42 having an elongated, rounded configuration. A leading portion 44 of the spacer 42 has a greater surface area than a trailing portion 46.

In a particularly preferred embodiment, the elongated spacers 42 have an airfoil configuration, as shown. As such, the airfoil is in the shape (as seen in cross-section) of a wing, blade (propeller, rotor or turbine) or sail or the like. As such, the leading portion or edge 44 is at the point at the front of the airfoil spacer that has a maximum curvature or radius. The trailing portion or edge 46 is defined as the point of minimum curvature or radius at the rear of the airfoil. The width or thickness, in cross-section, of the airfoil spacer 42 varies along the length thereof, and typically includes a curved outer or upper surface 48 and an inwardly directed curve 50 at a lower edge portion thereof.

The airfoil configuration of the elongated spacer 42 creates an aerodynamic feature and the force of two components, namely, lift and drag. The lifting force is generally perpendicular to the direction of motion, whereas the drag force is generally parallel to the direction of motion. As the fluid flows over the elongated spacer 42 having the airfoil configuration, there results a difference in pressure between the upper side or surface 48 and the lower side or surface 50 due to the speed over which the fluid flows due to their respective configurations. More particularly, a low pressure area is created at the upper surface 48 of the elongated airfoil spacer 42 and a positive pressure is created at the lower or bottom edge 50, causing lift forces generally perpendicular to the fluid flow, and directed outwardly of the disc 16. It will be appreciated that various configurations of an airfoil design may be implemented into the present invention so long as the aerodynamic effects of drag and lift, due to a difference in pressure between the upper and lower surfaces 48 and 50 are created.

Replacing the circular washers or spacers in the rotor assembly with properly designed and placed airfoil shaped spacers has been found to significantly improve the transfer of energy from the working fluid and produce greater torque for the same amount of fuel usage. As with the circular spacers, an airfoil of appropriate thickness provides exact spacing for the passage of the working fluid between the discs 16. Also, like the circular spacers, when the high velocity working fluid impacts the leading edge 44 of the airfoil spacer 42, there is a torque impulse created. However, at this point the shape and configuration of the elongated spacer 42 provides a distinct advantage over the circular spacer for the transfer of energy from the working fluid to the rotor 18 and the subsequent gain in torque. There is a much greater pressure differential created between the top and bottom surfaces 48 and 50 of the elongated spacer 42, particularly when having an airfoil configuration, and this exerts a very strong lifting force on the elongated spacer 42 itself. As the elongated spacers 42 are solidly attached between the discs 16, the energy of the lifting force is added to the rotor assembly in the direction of rotation, increasing the efficiency of the turbine 10.

Utilizing the elongated airfoil spacers 42 of the present invention instead of circular spacers combines the most positive attributes of a bladeless boundary layer turbine with the high efficiency of a bladed reaction steam turbine, resulting in a hybridized airfoil bladed boundary layer turbine. The use of the elongated spacers 42, particularly the airfoil configured spacers, has been found to significantly improve the transfer of energy from the working fluid, thus producing greater torque for the same amount of fuel usage. The energy of the lifting force is added to the rotor assembly in the direction of rotation.

Another advantage of utilizing a spacer having an elongated, rounded configuration, and particularly an airfoil configuration, is the increase in surface area along the smooth top and bottom surfaces 48 and 50 of the spacer 42 which provides a much larger area of interaction with the working fluid. The effect of boundary layer drag increases proportionally to the increase in surface area and the transfer of energy from the working fluid to the rotor assembly is thus greatly enhanced. As the elongated spacer 42 moves in the direction of the high velocity working fluid, this allows the working fluid to stay in contact with the spacer 42 and disc 16 for a longer period of time, thereby transferring additional energy to the rotor 18 and further improving efficiency.

In conventional airfoil design lift or speed are maximized and boundary layer drag is kept to a minimum in order to maximize efficiency. However, the design and implementation of an elongated, rounded spacer 42, and particularly a spacer having an airfoil configuration, is unique in that it provides both maximum lift and maximum boundary layer drag to optimize turbine efficiency.

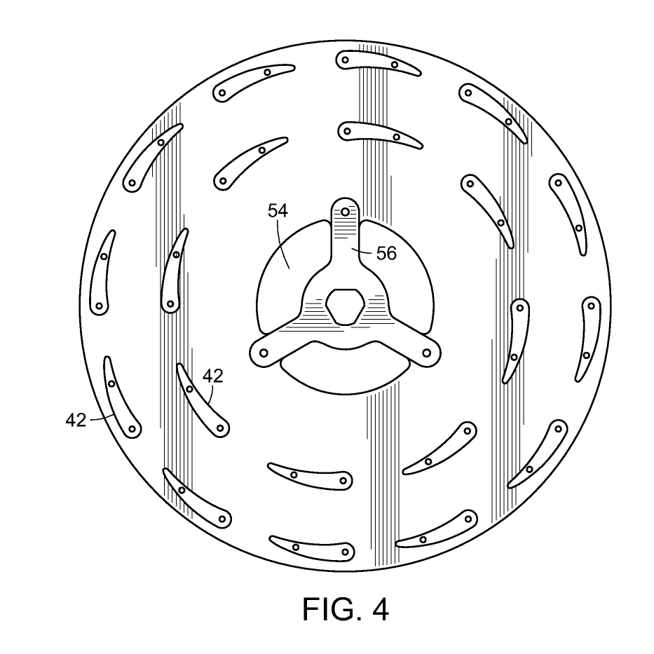

With reference now to FIGS. 3 and 4, in a particularly preferred embodiment, the elongated, airfoil spacers 42 embodying the present invention are disposed adjacent to an outer peripheral edge 52 of the disc 16, as illustrated. Historically, there has been a problem with the perimeter edges of the discs cracking and warping under prolonged oscillation and high RPMs and the elevated temperatures of the steam working fluid. This has generally been caused by the use of circular spacers that provide insufficient lateral support along the radii of the perimeter. Also, locating circular spacers too close to the disc perimeter has been found to reduce the amount of material between the edge of the disc and the spacer mounting hole which weakens that area, making it more susceptible to cracking and warping. Locating the circular spacers further in from the disc perimeter lessens their efficiency in producing rotor torque because of the reduced lever effect.

Replacing the circular spacers with the elongated or airfoil configured spacers 42 of the present invention creates a stabilizing effect that is created at the perimeter 52 of the disc 16 and rotor assembly due to the lifting force generated by the airfoil configuration of the spacer 42. This is the same principle as used in aircraft wing design that emphasizes lift and wing stability during flight. The airfoil shape is inherently more stable than the circular shape when operating in a high fluid velocity mass, such as air, steam or liquid.

The elongated or airfoil configured spacer geometry also places more spacer material along the perimeter 52 of the discs, thereby strengthening that region to prevent the problems mentioned above. Moreover, due to the enlarged size and configuration of the elongated, airfoil spacer 42, the spacer 42 may be mounted farther from the disc perimeter 52 in the working fluid stream. This increases the amount of disc material between the perimeter 52 and the spacer mounting holes, which adds to the strength of the material in that region. Aside from the additional spacer material strengthening the region, the configuration of the spacer 42 prevents adverse disc oscillation and subsequent disc failure.

With continuing reference to FIGS. 3 and 4, typically the elongated spacers 42 are arranged end-to-end. This may be in a generally circular pattern. In this manner, the leading portion or edge 44 of the elongated spacers 42 come into contact with the oppositely directed fluid stream, creating the advantages discussed above, which can be performed in sequence by arranging the elongated spacers end-to-end.

As shown in FIG. 3, the elongated spacers 42 of the present invention may replace the circular spacers 40 adjacent to the peripheral edge 52 of the disc 16, such that the circular spacers 40 are between the peripheral edge 52 and the elongated spacers 42 and the outlet apertures 54 and the rotating shaft 18. However, as illustrated in FIG. 4, all of the circular spacers 40 may be replaced by elongated spacers 42 having configurations embodying the present invention. This might comprise, for example, a second set of elongated spacers arranged end-to-end in a second generally circular pattern concentric to the first pattern, as illustrated in FIG. 4. It will also be appreciated that such a concentric circular pattern of first and second sets of elongated spacers 42 may also additionally include circular spacers 40. Moreover, there may be a spacer 56, such as the illustrated spacer having a star-configuration, immediately adjacent to the rotor shaft.

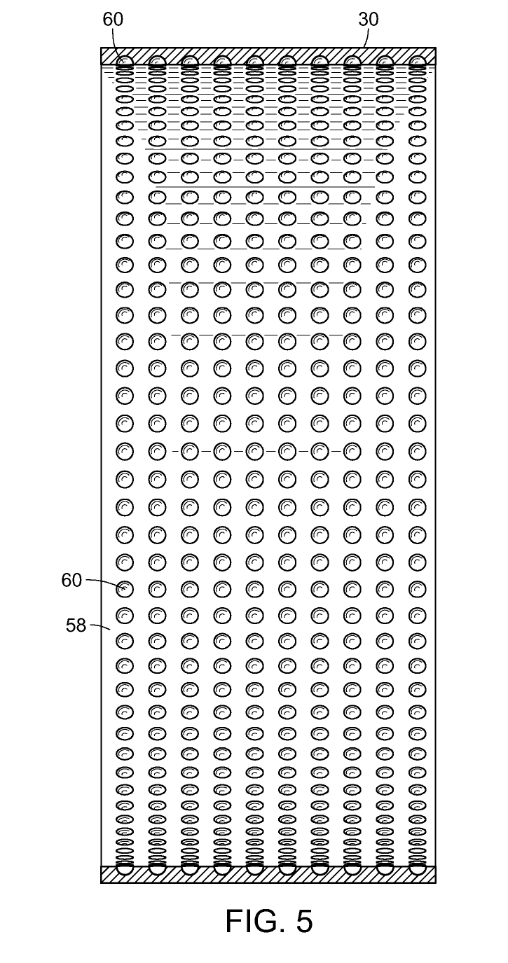

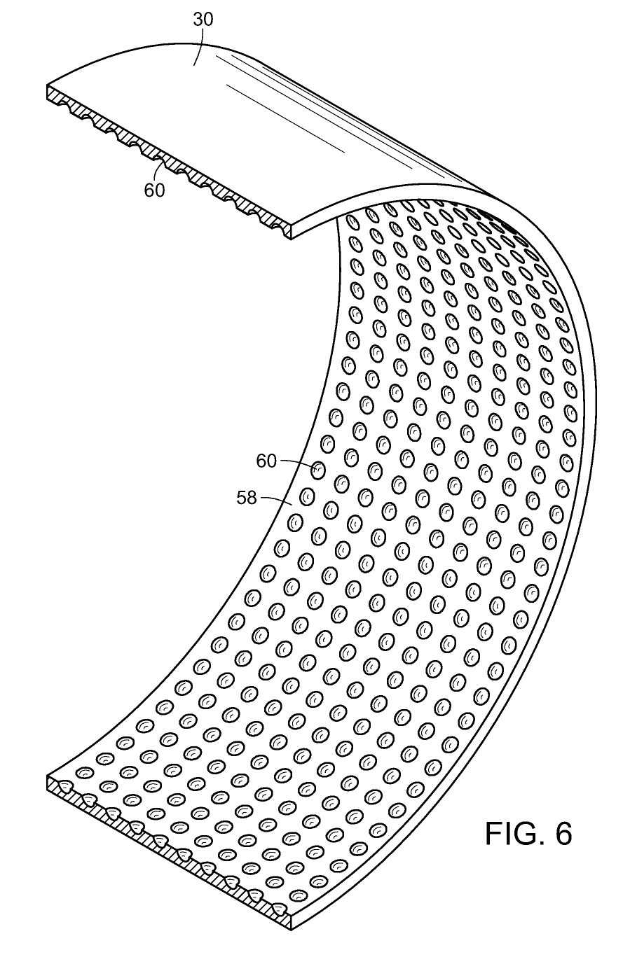

With reference again to FIG. 2, an inner surface 58 of the case ring, or other portion of the housing 20 adjacent to peripheral edges 52 of the rotor disc 16 may have spaced apart depressions formed therein. Such depressions 60 can be in the form of, for example, knurling, scoring, or dimpling on the inner surface 58 of the turbine case ring 30 or housing immediately adjacent to the perimeter of the disc of the rotor assembly. Such dimpling or depressions 60 may be formed in a pattern, as illustrated in FIGS. 2, 5 and 6.

As shown in FIG. 1, and particularly FIG. 3, there is a small clearance gap 62 in the region between the outer peripheral edge 52 of the rotor disc 16 and the inner surface of the case ring 30 or housing 20 such that the working fluid can come in contact with the case ring inner surface 58. If this surface is smooth, the inventors have found that a condition of boundary layer drag will occur and the velocity of the working fluid will be reduced. However, the inventors have discovered that if the surface is slightly rough or has regularly spaced small depressions 60 then a microlayer of turbulence will be created and the major portion of the working fluid in that area will not adhere to the surface 58 and pass by without losing velocity. This stream of working fluid can then interact with the airfoil spacers 42 in a smooth, laminar flow without added turbulence.

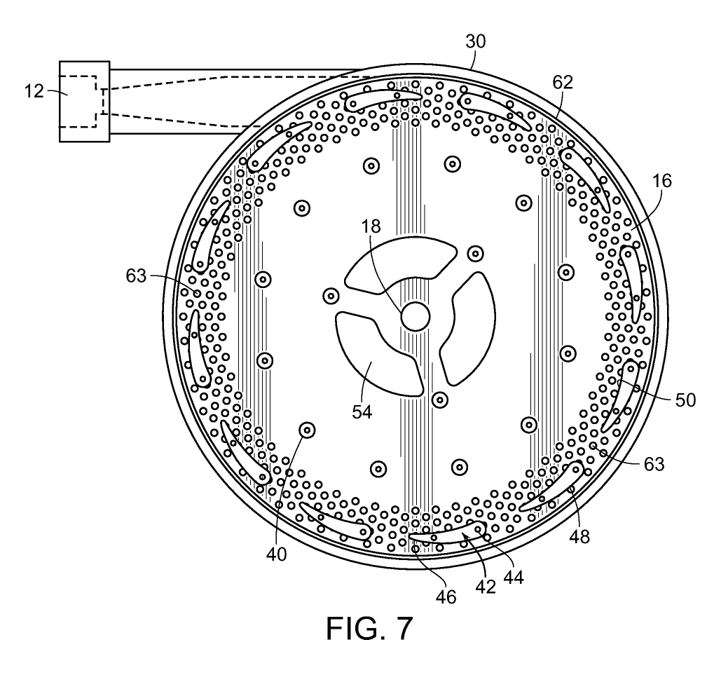

Similarly, as shown in FIG. 7, an outer portion of the rotor end disc surfaces that interact with the inside surfaces of the turbine case sides may also have a rough or knurled, scored or dimpled surface 63. For example, an outer portion, such as an outer 25% of the rotor end disc surface that interacts with the inside surfaces of the turbine case or housing sides adjacent to the end discs of the rotor assembly may be roughened, such as by knurling, scoring or dimpling, such that a microlayer of turbulence is created, which prevents boundary layer drag interaction between these two parts, thus reducing paralytic drag on the rotor. In other words, any small boundary layer or gap between internal surfaces of the housing 20 and the rotation disc 16 can be roughened, knurled, scored, dimpled, etc. to achieve this effect.

Although several embodiments have been described in detail for purposes of illustration, various modifications may be made without departing from the scope and spirit of the invention. Accordingly, the invention is not to be limited, except as by the appended claims.

What is claimed is:

1. A boundary layer turbine, comprising:
a housing having a fluid inlet and a fluid outlet;
a rotatable shaft at least partially disposed within the housing;
two or more rotor discs coupled to the shaft in spaced relation to one another;
spacers attached to a face of at least a plurality of the rotor discs, the spacers having an elongated configuration wherein a leading portion of the spacer has a greater surface area than a trailing portion of the spacer, wherein a lifting force is created as fluid passes over the elongated spacers.

2. The turbine of claim 1, wherein the elongated spacers comprise an airfoil.

3. The turbine of claim 1, wherein the elongated spacers are spaced from an outer peripheral edge of the rotor disc and arranged end to end.

4. The turbine of claim 3, wherein the elongated spacers are arranged in a first generally circular pattern.

5. The turbine of claim 4, including a second set of elongated spacers arranged end to end in a second generally circular pattern concentric to the first pattern.

6. The turbine of claim 1, including a plurality of the spacers having a generally circular configuration.

7. The turbine of claim 6, wherein the circular spacers are disposed intermediate the elongated spacers and the rotor shaft.

8. The turbine of claim 1, wherein an inner surface of the housing adjacent to peripheral edges of the rotor discs has spaced apart depressions formed thereon.

9. The turbine of claim 9, wherein the spaced apart depressions are formed as a pattern to create a thin layer of turbulence as fluid passes over the inner surface of the housing.

10. A boundary layer turbine, comprising:
a housing having a fluid inlet and a fluid outlet;
a rotatable shaft at least partially disposed within the housing;
two or more rotor discs coupled to the shaft in spaced relation to one another;
spacers attached to a face of at least a plurality of the rotor discs spaced from an outer peripheral edge of the rotor disc and arranged end to end, the spacers having an airfoil configuration wherein a leading portion of the spacer has a greater surface area than a trailing portion of the spacer, and wherein a lifting force is created as fluid passes over the elongated spacers.

11. The turbine of claim 10, wherein the airfoil spacers are arranged in a first generally circular pattern.

12. The turbine of claim 11, including a second set of airfoil spacers arranged end to end in a second generally circular pattern concentric to the first pattern.

13. The turbine of claim 10, including a plurality of the spacers having a generally circular configuration.

14. The turbine of claim 13, wherein the circular spacers are disposed intermediate the elongated spacers and the rotor shaft.

15. The turbine of claim 10, wherein an inner surface of the housing adjacent to peripheral edges of the rotor discs has spaced apart depressions formed thereon.

16. The turbine of claim 15, wherein the spaced apart depressions are formed as a pattern to create a thin layer of turbulence as fluid passes over the inner surface of the housing.

17. A boundary layer turbine, comprising:
a housing having a fluid inlet and a fluid outlet;
a rotatable shaft at least partially disposed within the housing;
two or more rotor discs coupled to the shaft in spaced relation to one another;
spacers attached to a face of at least a plurality of the rotor discs spaced from an outer peripheral edge of the rotor disc and arranged end to end in a generally circular pattern, the spacers having an airfoil configuration wherein a leading portion of the spacer has a greater surface area than a trailing portion of the spacer, and wherein a lifting force is created as fluid passes over the elongated spacers;
wherein an inner surface of the housing adjacent to peripheral edges of the rotor discs has spaced apart depressions formed thereon to create a thin layer of turbulence as fluid passes over the inner surface of the housing.

18. The turbine of claim 17, including a second set of airfoil spacers arranged end to end in a second generally circular pattern concentric to the first pattern.

19. The turbine of claim 17, including a plurality of the spacers having a generally circular configuration.

20. The turbine of claim 19, wherein the circular spacers are disposed intermediate the elongated spacers and the rotor shaft.
